(19) United States
(12) Patent Application Publication
(10) Pub. No.: US 2010/0297457 A1
(43) Pub. Date: Nov. 25, 2010

(54) (Meth) acrylate composition featuring reduced oxygen inhibition

(75) Inventors: Andreas Kramer, Zurich (CH); Steffen Maier, Wettingen (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 11/922,130

(22) PCT Filed: Mar. 8, 2006
(86) PCT No.: PCT/EP06/60540

§ 371 Date: May 30, 2008

(30) Foreign Application Priority Data
Jun. 17, 2005 (EP) 05105396.5

(51) Int. Cl. B32B 27/36; C08F 4/72; C08F 120/18

(52) U.S. Cl. 428/480; 526/90; 526/113; 526/117

(57) ABSTRACT

The invention relates to two-component or multicomponent compositions comprising at least the following ingredients: a) at least one (meth)acrylate; b) at least one compound of formula (I); c) at least one inorganic salt or a metal complex compound of at least one metal selected among the group encompassing the transition metals; and d) at least one peroxide or at least one perester or at least one hydroperoxide. A first component K1 contain at least ingredient c) while a second component K2 contains at least ingredient d). The inventive compositions are characterized in that oxygen inhibition is prevented or drastically reduced when the same are hardened. Said compositions are particularly suitable as adhesives, sealants, and coatings.

### TECHNICAL FIELD

The present invention pertains to the field of free-radically curing (meth)acrylate compositions.

### BACKGROUND ART

Free-radically curing (meth)acrylate compositions have been known for a long time. They are used as adhesives, sealants, and coatings. A substantial advantage is the rapid curing of these systems. A known disadvantage, however, is that the curing of (meth)acrylate may be inhibited by the oxygen present in the air. This results in the polymerization of the (meth)acrylates being greatly restricted where the monomers are in contact with air, and thus results in the formation of sticky surfaces. Stickiness of this kind, however, is a great disadvantage, since on the one hand it is possible for dust to adhere at these points and so lead to visible soiling, and on the other hand the noncrosslinked or weakly crosslinked monomers lead to a greasy and sticky surface which is unpleasant to touch. Furthermore, the inhibition results in odors being emitted and in contamination due to unreacted monomers. These effects are a great disadvantage particularly where large areas are in contact with air, more particularly in the case of coatings. For a long time, therefore, attempts have been made to be able to reduce or prevent entirely the oxygen inhibition. One starting point for these efforts is the use of paraffins, which dissolve in the monomers and become incompatible in the course of curing, at which point they accumulate at the surface and thus form a shield against the air. This version of a solution to the oxygen inhibition, however, is very disadvantageous for two reasons. On the one hand, the balance between solubility and incompatibility is very delicate and very heavily dependent on the particular monomer, with the consequence that only certain selected (meth)acrylates can be used in the respective formulations. On the other hand, the recoatability of (meth)acrylate systems of this kind is difficult, as a result of the presence of paraffin on the surface, without the removal of said paraffin, with the consequence that adhesion problems occur for the attachment of subsequent coats. Another starting point for a solution to the oxygen problem is the coating of the surface with an inert gas, or operation under inert gas. Examples of such inert gases are nitrogen, argon or CO₂. This method, however, is very costly and inconvenient, and is typically suitable only for small surfaces. The same applies to a further solution, namely that of operating under reduced pressure. A further possibility for reducing the oxygen inhibition is appropriate when using volatile compounds or monomers, which evaporate during the polymerization and so displace the air from the surface. This possibility is realized, for example, in the case of the polymerization of methyl methacrylate and methyl acrylate. These monomers have a high volatility, and therefore only a low level of oxygen inhibition is observed in the case of formulations based on these monomers. A disadvantage with this solution, however, is that the high quantities of volatilizing compounds give rise to problems with the odor and/or with the toxicity and/or workplace safety. A further method is that of operating at elevated temperature or carrying out heat treatment after the polymerization at relatively high temperatures. This likewise reduces the stickiness. A disadvantage in this case, however, is that the heating on the one hand is costly and labor-intensive and on the other hand can be implemented in practice only for relatively small areas or workpieces. Finally, the sticky layer which forms as a result of the oxygen inhibition can also be removed. This can be done mechanically or by wiping with a suitable solvent. The removal, however, on the one hand is an additional workstep and on the other hand can damage the polymerized surface.

The use of β-dicarbonyl compounds in air-drying systems is known. Air-drying systems of this kind have polymers of relatively high molecular mass and in particular have no peroxides or hydroperoxides, but instead react via oxygen through oxidative crosslinking of double bonds, and are very slow in particular by comparison with (meth)acrylates. DE-A-26 01 378, for example, discloses the use of derivatives of γ-butyrolactone and δ-valerolactone in air-drying polyester resins. These air-drying polyester resins are styrene-based polycondensation products of unsaturated dicarboxylic acids and polyols. DE-A-30 44 695 describes an air-crosslinking coating material where β-dicarbonyl compounds are added to a copolymer.

### BRIEF DESCRIPTION OF THE INVENTION

It is an object of the present invention, therefore, to overcome the disadvantages of the prior art, and more particularly to find a way of achieving rapid curing in the case of (meth)acrylates, where the inhibition caused by the oxygen is prevented or at least greatly reduced. More particularly this ought also to be possible for nonodorous (meth)acrylates or those with only a low level of odor.

Surprisingly this object is achieved by means of a two-component or pluricomponent composition in accordance with claim 1.

The composition allows rapid curing in the presence of oxygen, the oxygen inhibition being reduced entirely or at least greatly, particularly in comparison to the analogous (meth)acrylate composition without the compound of formula (I) and without the metal salt or metal complex compound of claim 1.

The composition, furthermore, has excellent mechanical properties, which can be varied broadly and with which it is possible to realize not only thin-film coatings but also high-build coatings, and also sealants and adhesives.

More particularly it is also possible with this composition to realize formulations which are free from compounds known to have a strong and nuisance odor, such as methyl (meth)acrylate or styrene.

### EMBODIMENTS OF THE INVENTION

The present invention relates to two-component or pluricomponent compositions which comprise at least the following ingredients:
a) at least one (meth)acrylate;
b) at least one compound of the formula (I);
c) at least one metal salt or metal complex compound of at least one metal selected from the group of the transition metals;
d) at least one peroxide or at least one perester or at least one hydroperoxide;
   a first component K1 comprising at least ingredient c), and a second component K2 comprising at least ingredient d).

The term “component” or “-component” is used not in the sense of “ingredient”, but instead means that one substance or one substance mixture is stored separately from another substance or substance mixture. Throughout the document the term “(meth)acrylate” refers to esters of acrylic acid (=“acrylate”) or of methacrylic acid (=“methacrylate”), which therefore contain at least one CH₂═CH—CO—O— or at least one CH₂═C(CH₃)—CO—O— group.

The word “metal” throughout the document is used not in the sense of “metallic”, but instead stands for a metal cation in a salt or for a metal cation bonded to ligands in a complex compound.

By “transition metals” are meant, throughout the document, not only the metals of atomic number 21-30, 39-48, 57-80, and 89 to 109 of the Periodic Table (in other words, the term also embraces the so-called lanthanides) but also the actinides.

The two-component or pluricomponent composition comprises at least the two components K1 and K2.

The first component, K1, comprises at least ingredient c). In other words, component K1 consists of or comprises at least one metal salt or metal complex compound of at least one metal selected from the group of the transition metals.

The metal of the at least one salt or of the metal complex compound is preferably a metal which is selected from the group containing cobalt, manganese, vanadium, iron, copper, chromium and zirconium.

The second component, K2, comprises at least ingredient d). In other words, component K2 consists of or comprises at least one peroxide or at least one perester or at least one hydroperoxide.

The two-component or pluricomponent composition comprises ingredient a), namely at least one (meth)acrylate.

Suitable in principle are all of the monomers and oligomers that are employed in the adhesives and sealants and coatings fields. Special suitability, however, is possessed in particular by those monomers and oligomers which have little or no odor. For this reason, in particular, methyl (meth)acrylate, for example, is not a preferred monomer.

It has emerged that particularly suitable (meth)acrylates are those which in the ester moiety have a heteroatom, more particularly an oxygen atom, which is at least 1 but less than 5, more particularly 2 or 3, carbon atoms away from the marked oxygen atom designated by an asterisk in the formula (VI)

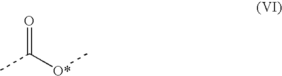

Examples of (meth)acrylates of this kind are hydroxymethyl (meth)acrylate, hydroxyethyl (meth)acrylate (HEA, HEMA), hydroxypropyl (meth)acrylate (HPA, HPMA), hydroxybutyl (meth)acrylate (HBA, HBMA), more particularly hydroxyethyl (meth)acrylate (HEA, HEMA) and hydroxypropyl (meth)acrylate (HPA, HPMA).

Further examples of (meth)acrylates of this kind are 2-(2-ethoxyethoxy)ethyl (meth)acrylate, 2-phenoxyethyl (meth)acrylate, caprolactone (meth)acrylate (OH—(CH₂)₅COO—(CH₂)₅COOCH₂CH₂CH═CH₂), methoxypolyethylene glycol mono(meth)acrylate, polypropylene glycol mono(meth)acrylate, polyethylene glycol mono(meth)acrylate, tetrahydrofurfuryl (meth)acrylate, furfuryl (meth)acrylate, 1,3-butylene glycol di(meth)acrylate, 1,4-butanediol di(meth)acrylate, diethylene glycol di(meth)acrylate, dipropylene glycol di(meth)acrylate, ethoxylated bisphenol A di(meth)acrylate, trimethylolpropane tri(meth)acrylate, ethylene glycol monoacetoacetate mono(meth)acrylate, and 2-dimethylaminoethyl (meth)acrylate.

Methacrylates are preferred over acrylates.

Particular preference is given to tetrahydrofurfuryl (meth)acrylate, ethylene glycol monoacetoacetate mono(meth)acrylate, hydroxyethyl (meth)acrylate, and hydroxypropyl (meth)acrylate.

The two-component or pluricomponent composition comprises ingredient b), namely at least one compound of the formula (I).

Compounds of the formula (I) are

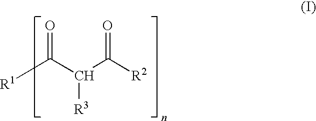

The index n in this formula is a number from 1 to 20. Preferably n is a number 1, 2, 3, 4, 5 or 6. Preferably n is 1. The substituent R¹ is an n-valent organic radical.

An “n-valent organic radical” here and below means an organic radical to which there are n bonds. Thus, for example, alkyl, aryl, aralkyl, cycloalkyl, oxyalkyl and oxyaryl are monovalent radicals, methylene or phenylene are divalent radicals, while, for example, 1,2,3-butane-triyl

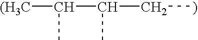

is a trivalent radical.

The substituent R² is an unsubstituted or substituted alkyl group, cycloalkyl group, aryl group or aralkyl group, or R² together with R³ forms a ring which if appropriate comprises heteroatoms in or on the ring, or R² is a radical OR⁴. R⁴ in this case is an unsubstituted or substituted alkyl group, cycloalkyl group, aryl group or aralkyl group, or R⁴ together with R³ forms a ring which if appropriate comprises heteroatoms in or on the ring.

The substituent R³ is an unsubstituted or substituted alkyl group, cycloalkyl group, aryl group or aralkyl group or together with R² forms a ring which if appropriate comprises heteroatoms in or on the ring.

Thus, the substituents R² and R³ independently of one another may each be an alkyl group, cycloalkyl group, aryl group or aralkyl group, which if necessary can be substituted. Or the substituents R² and R³ together form a ring. This ring that is formed is typically formed by carbons joined to one another. Within this ring, however, there may also be heteroatoms, or else there may be heteroatoms joined to the atoms which form the ring.

It is particularly preferred if the radicals R² and R³ are joined to one another and form a ring.

Suitable n-valent organic radicals for R¹ are on the one hand divalent radicals such as alkylene, phenylene, cycloalkylene, oxyalkylene and poly(oxyalkylene) groups. Preference is given to ethylene, propylene, and cyclohexylene. On the other hand, trivalent to typically hexavalent radicals are possible, deriving, for example, from cycloaliphatics or benzene derivatives.

Particularly preferred n-valent radicals are heteroatom-containing n-valent organic radicals R¹.

Particularly suitable n-valent radicals R¹ are those deriving from polyols of the formula R¹′ (OH)ₙ. In these radicals R¹ is a radical R¹′(O)ₙ, i.e., an alcohol R¹′(OH)ₙ having n hydroxyl groups, after the removal of all the protons of all the hydroxyl groups.

Examples deserving of particular emphasis of monovalent radicals are alkyl groups, such as ethyl groups or methyl groups.

Preferred examples of dihydric alcohols of this kind are polyetherdiols, polyesterdiols, polycarbonatediols, and hydrogenated polybutadienes. Particularly preferred are diols of the formula (II)

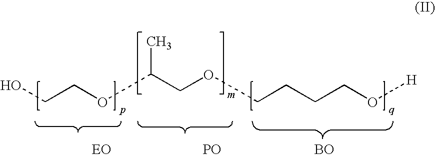

where the indices p, m and q stand for the values p=0−65, m=0−65, q=0−65, and the sum of m, p, and q is a number from 1 to 65. The units which come about when these polyols are prepared from ethylene oxide, propylene oxide, and butylene oxide, and which are therefore denoted “EO”, “PO”, and “BO” in formula (II), may, if the products are copolymers, be randomly or blockwise arranged. This is indicated through the use of dashed bonds in formula (II). The arrangement can be obtained by means of the processes known for that purpose.

Suitable trivalent radicals R¹ are more particularly the radicals derived from triols. Triols of this kind are glycerol (1,2,3-propanetriol), trimethylolpropane, trimethylolethane, and their alkoxylated derivatives.

Suitable tetravalent radicals R¹ are more particularly the radicals derived from tetrols. Tetrols of this kind are pentaerythritol, α,α′-diglycerol (bis(2,3,-dihydroxypropyl)ether), di(trimethylolpropane) (2,2′-oxybis(methylene)bis(2-ethyl-1,3-propanediol) and di(trimethylolethane) (3-(3-hydroxy-2-hydroxymethyl-2-methylpropoxy)-1-hydroxymethyl-2-methylpropan-1-ol), and also their alkoxylated derivatives.

Suitable hexavalent radicals R¹ include more particularly the radicals derived from hexyls. Examples of hexyls of this kind are (di(pentaerythritol) (3-(3-hydroxy-2,2-bishydroxymethylpropoxy)-2,2-bis-hydroxymethylpropan-1-ol) and also the alkoxylated derivatives thereof.

Further preferred radicals R¹ derive from sugars or sugar alcohols. Sugars of this kind are monosaccharides or disaccharides or trisaccharides. Sugar alcohols are, in particular, tetritols, pentitols, and hexitols. These sugars and sugar alcohols may be chemically modified, such as alkoxylated, for example.

An alcohol R¹′(OH)ₙ of this kind is preferably trimethylolpropane, pentaerythritol, glycerol or a sugar or a diol of the formula (II).

Compounds of the formula (I) of this kind, derived from an n-valent alcohol R¹′(OH)ₙ, can be obtained, for example, by a transesterification of the corresponding methyl ester:

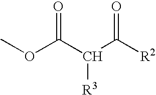

A particularly preferred methyl ester is the following methyl ester:

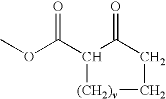

with v=1, 2 or 3.

Transesterifications can be carried out by known processes, such as those described, for example, in Jerry March, “Advanced Organic Chemistry”, 3rd Edition, John Wiley & Sons, 1985, pp. 351-353.

In a further embodiment, the n-valent alcohol R¹′(OH)ₙ is an OH-terminated polyurethane prepolymer. OH-terminated polyurethane prepolymers of this kind are obtained in a manner known to the skilled worker: for example, by the reaction of at least one polyol with at least one polyisocyanate, the polyol being used in a stoichiometric excess of the hydroxyl groups over the isocyanate groups.

In a further embodiment the index n is 1 and R¹ is an unsubstituted or substituted alkyl group, cycloalkyl group, aryl group or aralkyl group or is a radical OR⁵. In this case R⁵ in its turn is an unsubstituted or substituted alkyl group, cycloalkyl group, aryl group or aralkyl group or a group of the formula (III)

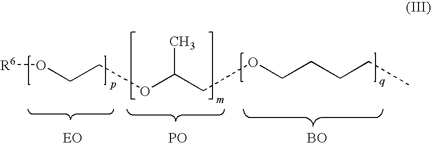

R⁶ is a C₁ to C₄ alkyl group and the indices p, m and q are the values p=0−65, m=0−65, q=0−65. The sum of m, p and q produces a number from 1 to 65. The units which come about when these polyols are prepared from ethylene oxide, propylene oxide, and butylene oxide, and are therefore designated “EO”, “PO”, and “BO” in formula (III), can, where the products are copolymers, be randomly or blockwise arranged. This is indicated by the use of dashed bonds in formula (II). The arrangement can be obtained by means of the processes known for this purpose.

In one preferred embodiment the compound of the formula (I) is a compound of the formula (IV) or (V)

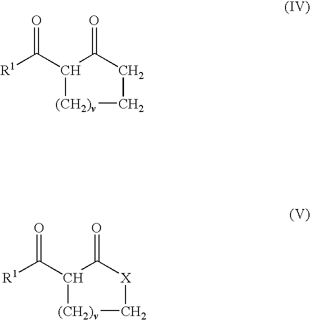

where v=1, 2 or 3 and X is O, S or an NR⁷, where R⁷ is H or is an unsubstituted or substituted alkyl group, cycloalkyl group, aryl group or aralkyl group.

Preferably v is 1 or 2.

Preferably X is an oxygen atom.

In one preferred embodiment the compound of the formula (I) is a compound of the formula (IV) and R¹ is a radical OR⁵ where R⁵ is an unsubstituted or substituted alkyl group, cycloalkyl group, aryl group or aralkyl group or is a group of the formula (III).

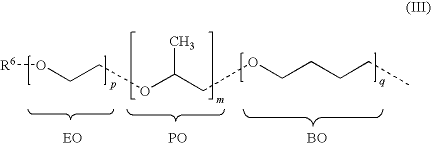

R⁶ is a C₁ to C₄ alkyl group and the indices p, m, and q are the values p=0−65, m=0−65, q=0−65. The sum of m, p and q produces a number from 1 to 65. The units which come about when these polyols are prepared from ethylene oxide, propylene oxide, and butylene oxide and are therefore designated “EO”, “PO”, and “BO” in formula (III), can, where the products are copolymers, be randomly or blockwise arranged. This is indicated by the use of dashed bonds in formula (II). The arrangement can be obtained by means of the processes that are known for this purpose.

Furthermore, the compounds of the formula (I) may also be thioesters or amides, which can be prepared, for example, from the corresponding methyl ester or ethyl ester (R¹=-OMe or -OEt) and from the respective mercaptan or amine.

In a further preferred embodiment the compound of the formula (I) is a compound of the formula (V) and R¹ is an unsubstituted or substituted alkyl group, cycloalkyl group, aryl group or aralkyl group, preferably a C₁-C₆ alkyl group.

In one particularly preferred embodiment the compound of the formula (I) is acetylbutyrolactone or ethyl cyclopentanone-2-carboxylate or methyl cyclopentanone-2-carboxylate.

For the invention it is essential that in the compound of the formula (I), the carbon atom which joins the two carbonyl groups to one another has exactly one H bonded to this carbon atom. Compounds which have no H or two H do not produce the desired advantages.

The two-component or pluricomponent composition comprises ingredient c), namely at least one metal salt or metal complex compound of at least one metal selected from the group of the transition metals, more particularly selected from the group containing cobalt, manganese, vanadium, iron, copper, chromium and zirconium.

Metal salts or metal complex compounds which have proven particularly suitable are those of the metals cobalt, manganese and vanadium.

It is possible for there to be mixtures of metal salts or metal complex compounds of different metals or the same metals.

In one embodiment there are mixtures of at least two metal complex compounds of at least two metals. In one embodiment there is at least one manganese complex and one cobalt complex and/or one vanadium complex. In one particularly preferred embodiment there is at least one cobalt complex and one manganese complex and/or one vanadium complex.

Metal salts or metal complex compounds have proven particularly suitable, more particularly those based on carboxylic acids, especially naphthenates, octoates or ethylhexanoates, preferably octoates. There may be further additives such as accelerants and complexing agents. Particularly suitable metal salts or metal complex compounds are those sold, for example, by the company Borchers, Langenfeld, Germany under the product series with the trade name Borchers® Octa-Soligen® or Borchers® Dry.

The two-component or pluricomponent composition comprises ingredient d), namely at least one peroxide or at least one perester or at least one hydroperoxide.

The ingredients in question are, on the one hand, hydrogen peroxide and, on the other hand, organic peroxides, peresters or hydroperoxides of the kind widely available commercially.

Hydroperoxides are particularly preferred. Particular preference is given to cumene hydroperoxide and p-isopropylcumene hydroperoxide. A preferred peroxide is benzoyl peroxide. On the basis of its excellent properties and on account of its low odor, p-isopropyl-cumene hydroperoxide is particularly preferred.

In particular tert-Butyl perbenzoate has proven particularly suitable as a perester.

The two-component or pluricomponent composition may comprise further constituents, more particularly fillers, thioxotropic agents, impact modifiers, catalysts, activators, chelate ligands, solvents, plasticizers, pigments, dyes, additives such as adhesion promoters, flow control agents, emulsifiers, inhibitors, and also UV stabilizers and heat stabilizers, etc.

In order to accelerate the reaction it is possible to use an activator. Suitable activators are known to the skilled worker. Mention may be made, as nonlimiting examples, of the following: tertiary amines such as N,N-dimethylaniline, N,N-diethylaniline, N,N-dimethyl-toluidene, N,N-diethyltoluidine, N,N-bis(2-hydroxy-ethyl)-p-toluidine, ethoxylated p-toluidines, N,N-bis-(2-hydroxyethyl)-p-toluidine, etc. Toluidine derivatives are considered particularly preferred activators, more particularly N,N-dialkyltoluidines. Suitable tertiary amines, especially p-toluidines, may also be alkoxylated.

Examples of appropriate fillers include chalks, preferably coated chalks, and also finely ground quartz, barium sulfate, fumed silica, and filled or hollow glass or ceramic beads.

Phthalates and adipates are especially preferred as plasticizers, more particularly diisononyl phthalate, diisodecyl phthalate (DIDP) or dioctyl adipate (DOA).

Possible synergists are the substances known for this purpose to the skilled worker. The compounds in question here are, more particularly, compounds of the metals potassium, calcium and barium. In particular these compounds are based on carboxylic acid derivatives. Particular suitability is possessed by potassium, calcium or barium octanoates.

Impact modifiers are used in order to enhance the impact strength of the cured composition. Preference is given to liquid rubbers and core-shell polymers.

Liquid rubbers are more particularly those sold under the trade name Hycar® by Noveon. They may be, for example, butadiene-acrylonitrile copolymers modified with acrylic groups, such as those from the product series Hycar® VTBNX, for example.

Particularly preferred core-shell polymers are those core-shell polymers as available commercially under the trade name Paraloid® from Rohm and Haas.

It has proven particularly advantageous if a mixture of liquid rubber and core-shell polymer is used as impact modifier.

The two-component or pluricomponent composition preferably comprises, as well as ingredients a), b), c) and d) additionally activators, fillers and, if necessary, plasticizers.

With even greater preference it further comprises impact modifiers.

It is preferred for the two-component or pluricomponent composition to be free or very largely free from odorous compounds. Particularly undesirable are those compounds which have a strong and unpleasant odor, such as styrene or methyl (meth)acrylate.

It has been found, surprisingly, that, as well as the odor, systems containing styrene are also disadvantageous in that they prolong the drying time.

Consequently, the two-component or pluricomponent composition is preferably free from styrene. With similar preference it is free both from styrene and from unsaturated polyester resins.

The subdivision of ingredients a), b) and the other possible ingredients between components K1, K2 and, where appropriate, further possible components may be very different.

It is important that ingredients c) and d) must not be present in the same component. Accordingly component K1 comprises at least ingredient c), and component K2 comprises at least ingredient d).

In one embodiment the two-component or pluricomponent composition is a three-component composition. A preferred three-component composition is one having a third component K3 which comprises at least ingredient a); and where at least ingredient b) is part of component K1 or K2 or K3. It is preferred here for ingredient b) to be part of component K1.

In another, preferred, embodiment the two-component or pluricomponent composition is a two-component composition. In one embodiment ingredient a) is part of component K2. In that case ingredient b) is part of component K1 or K2, but preferably part of component K1. This embodiment is preferred especially when the (meth)acrylate has an ether group, more particularly in the case of tetrahydrofurfuryl (meth)acrylate.

In another, preferred, embodiment of a two-component composition ingredient a) is part of component K1. In that case ingredient b) is part of component K1 or K2, but preferably part of component K1.

It is generally preferred when ingredient b) is present in component K1.

The fraction of the compound of the formula (I) is preferably 0.1% to 20% by weight, more particularly 0.1% to 10% by weight, preferably 1% to 5% by weight, based on the weight of the two-component or pluricomponent composition. Particularly when the radical R¹ is of relatively high molecular mass, typically when the radical R¹ has a molecular weight of more than 100 g/mol, more particularly more than 400 g/mol, it is preferred for the fraction of the compound of the formula (I) to be 0.1% to 20% by weight, more particularly 1% to 20% by weight, preferably 3% to 10% by weight.

The fraction of the compound of the at least one metal salt or of the metal complex compound, calculated as the metal, is preferably 0.001% to 0.5% by weight, more particularly 0.01% to 0.4% by weight, especially 0.01% to 0.2% by weight, based on the weight of the two-component or pluricomponent composition.

The fraction of the at least one (meth)acrylate preferably has the greatest fraction by weight of the ingredients a), b), c) and d). The ratio a)/[a)+b)+c)+d)] is typically greater than 0.7, more particularly 0.8-0.999, preferably 0.9-0.99.

The fraction of (meth)acrylate is typically more than 20% by weight, more particularly 30%-99% by weight, preferably 40%-95% by weight, based on the weight of the two-component or pluricomponent composition.

It is preferred for ingredient b) to be used stoichiometrically or in excess in relation to ingredient c). This means that the molar ratio [formula (I)]/(n*[M]) is ≧1, where [M] is the amount of the metal of the metal salt or metal complex compound in moles and [formula (I)] is the amount of the compound of the formula (I) in moles, and n is the index in formula (I).

It has emerged that, with a mixture comprising at least ingredients b) and c), the oxygen inhibition in the polymerization of (meth)acrylates can be drastically reduced, and in particularly preferred cases can even be eliminated.

Components K1, K2 and, where appropriate, the further components are stored separately from one another. They can be stored, for example, in drums, hobbocks or cartridges. This mutually separate storage, however, also includes storage in packaging forms which have two chambers joined to one another by at least one partition.

In one embodiment these packaging forms are double cartridges, of the kind known from two-component adhesives, there being different possible arrangements of the chambers. By way of example they may be cylindrical chambers which can be arranged adjacently (in parallel) or concentrically. The walls of the chambers may be rigid or flexible. Particularly suitable are what are called twin cartridges (parallel arrangement) or cartridge-in-cartridge double cartridges (concentric arrangement). An exemplary arrangement of the chambers and their configuration can be found in WO 01/44074 or in U.S. Pat. No. 6,433,091 B1.

In one embodiment, one component can be present in a packaging form from which this component is metered and mixed into a stream of the other component. An example of the packaging form or metered addition of this kind can be found in, for example, WO 95/24556, Packaging/metering devices of this kind are advantageously screwed onto a cartridge outlet or onto the outlet aperture of an adhesive pump.

In another embodiment the admixing of one component to the other component and the mixing of the two components takes place by means of a dynamic mixer.

In a further embodiment one component is introduced through a nozzle or nozzles to the other component, in particular by way of a plurality of distributed nozzles, and then the components are mixed.

The mixing of the one component into the other component can take place homogenously or in layers. Layers are obtained particularly when a small number, typically between 3 and 10, of mixing elements are arranged within a static mixer.

If homogenous mixed incorporation is desired, it is preferred to use either a dynamic mixer or a large number of mixing elements in a static mixer.

For use, components K1, K2 and, where appropriate, further components present are mixed with one another immediately before or during application. In the case of more than two components, all of the components can be mixed simultaneously with one another or with time offsets.

Mixing may take place manually or by machine. Mixing is preferably accomplished with the aid of a static mixer or with the aid of a dynamic mixer.

The two-component or pluricomponent composition can be used more particularly as an adhesive or sealant or as a coating.

In the case of its use as an adhesive, the following method can be used:
mixing the two or plural components of the two-component or pluricomponent composition
applying this mixture to a surface of a substrate S1
contacting a surface of a further substrate S2 with the mixture applied to substrate S1, the substrates S1 and S2 being of the same or different material,
curing the mixed composition.

In the context of its use as a sealant, the following method may be used:
mixing the two or plural components of the two-component or pluricomponent composition
applying this mixture to a surface of a substrate S1
contacting a surface of a further substrate S2 with the mixture applied to substrate S1, the substrates S1 and S2 being of the same or different material,
curing the mixed composition.

In the context of its use as a coating material, the following method can be used:
mixing the two or plural components of the two-component or pluricomponent composition
coating a substrate S1 with this mixture
curing the mixed composition in air.

The substrates S1 and S2 with which the mixed two-component or pluricomponent composition comes into contact may be diverse in their nature. They may be natural or artificial substrates. More particularly they are mineral substrates such as concrete, stone, masonry, rock and the like, or metals and metal alloys, such as, for example, aluminum, steel, brass, copper or metal sheet, plastics such as polyvinyl chloride (PVC), acrylonitrile-butadiene-styrene copolymers (ABS), SMC (sheet molding compound), polycarbonate (PC), polyamide (PA), polyester (PE), polyoxymethylene (POM), polyolefins, especially polyethylene (PE) or polypropylene (PP), preferably PE or PP surface-treated by plasma, corona or flame, or polymeric materials such as paints.

The articles produced by a method of this kind find broad application in construction, especially building construction and civil engineering, and in industry, especially in vehicle construction.

The two-component or pluricomponent compositions are notable for a marked reduction, or in particularly preferred cases even the complete elimination, of oxygen inhibition. The consequences of this are that the compositions are rapidly tack-free and dust-dry without the need for costly and inconvenient after-treatment by means of heat or removal of the sticky layer. This is particularly important in those applications where large areas of the composition to be cured are in contact with the air. Consequently, application as a coating or high-build adhesive bond or seal is an application in which the advantages of the composition of the invention are manifested to a particular extent.

Coatings include, on the one hand, thin-film coatings, examples being a paint or protective coating. On the other hand, coatings include high-build coatings or coverings, in the form, for example, of floors.

For applications on large areas and/or in interiors it is extremely advantageous if the applied composition is as far as possible odorless during and after application. Consequently the two-component or pluricomponent compositions are particularly suitable for the production of floors or for coating within buildings, or for coatings, adhesive bonds, and seals in enclosed or poorly ventilated interiors. In interior domestic and working spaces in particular, but also in vehicle construction, the demand for particularly odorless coating materials, sealants, and adhesives is particularly great.

The two-component or pluricomponent compositions are notable for very rapid curing. This is especially important in those instances when the articles produced are heavily loaded or must be processed further: for example, the recoating or traversal of a coating, or the movement or transportation of an adhesive bond or sealed bond.

For this reason the compositions are especially suitable as assembly adhesives. Assembly adhesives of this kind are suitable more particularly for use for adhesive bonding on a production line in the industrial production of articles, more particularly articles of everyday use such as white goods, for example, such as washing machines, or of vehicles, more particularly of automobiles.

### EXAMPLES

### Production of Two-Component or Pluricomponent Compositions

### Test Methods

Approximately 4.5 ml of the compositions described below were applied to a glass plate provided with a margin. In this way a coating with an area of 290 mm×15 mm and a thickness of approximately 1 mm was obtained.

Thereafter the following test methods were used:
Base Layer Cure Time (“t_{c/bl}”)

At regular intervals a metal spatula was lowered into the coating, and a determination made of whether it was possible to contact the glass plate. The base layer cure time reported was the point in time, measured from the addition of the last ingredient, at which it was no longer possible for the metal spatula to contact the glass surface.

Drying Time (“t_{d}”)

The drying time was determined using a Drying Recorder from The Mickle Laboratory Engineering Co. Ltd., Gomshall, Surrey (England). Measurement took place over a distance of 29 cm, which was traveled in 6 h. In the case of the very slow reference systems, the path was traveled in 24 hours. In place of a needle, an incised plastic pipette with a tip diameter of approximately 1 mm was used, and was placed in such a way that the tip of the pipette was approximately 1 mm above the coating surface. As soon as the base layer of the substrate had undergone initial curing (manual testing by contact with a spatula), sand (grain size 0.08-0.2 mm) was inserted into the top opening of the incised pipette and was moved along the surface using the device. The sand-filled pipette guided over the coating surface thus left a sand track on the surface. Following the removal of the sample from the test device at the end of the measurement time, the sand was wiped away gently using a brush. The “drying point” ascertained was the point at which sand no longer adhered to the surface. The drying time was calculated from the path covered from the start point to the “drying point” and from the base layer cure time.

### Variation of Ingredient b)

10.0 g of Tetrahydrofurfuryl methacrylate (SR203, Sartomer), 0.10 g of Bisomer PTE® (Cognis), and 0.10 g of Octa-Soligen® Cobalt-12 (Borchers, cobalt content: 12% (0.2 mmol of Co)) were combined in a polyethylene container and mixed in a Speedmixer at 3000 rpm for 30 seconds. Thereafter 2 mmol of a dicarbonyl compound (“DCC”) as per Table 1 were added in each case, and the ingredients were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above.

TABLE 1
Variation of the dicarbonyl compound

| | Dicarbonyl compound | [Co]/[DCC] | t_{c/bl} | t_{d} |
|---|---|---|---|---|
| Designation | (DCC) | [mmol]/[mmol] | [min] | [min] |
| Ref. 1 | — | — | 200 | 310 |
| Ref. 2 | 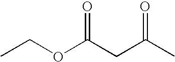 | 0.2/2.0 | 200 | 320 |
| Ref. 3 | 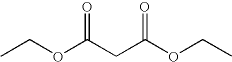 | 0.2/2.0 | 210 | 320 |
| Ref. 4 | 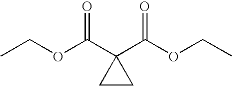 | 0.2/2.0 | 200 | 310 |
| Ref. 5 | 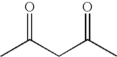 | 0.2/2.0 | >24 h | >24 h |
| 1 | 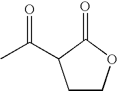 | 0.2/2.0 | 25 | 80 |
| 2 | 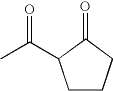 | 0.2/2.0 | 25 | 150 |
| 3 | 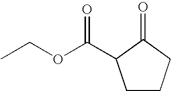 | 0.2/2.0 | 35 | 45 |
| 4 | 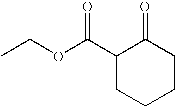 | 0.2/2.0 | 60 | 150 |
| 5 | 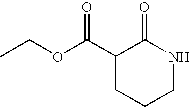 | 0.2/2.0 | 40 | 160 |
| 6 | 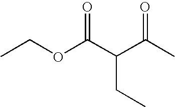 | 0.2/2.0 | 145 | 250 |

### Variation of the Ratio of Ingredient b) to Ingredient c)

10.0 g of Tetrahydrofurfuryl methacrylate (SR203, Sartomer), 0.10 g of Bisomer PTE® (Cognis), and 0.10 g of Octa-Soligen® Cobalt-12 (Borchers, cobalt content: 12% (0.2 mmol of Co)) were combined in a polyethylene container and mixed in a Speedmixer at 3000 rpm for 30 seconds. Subsequently 2-acetylbutyrolactone (ABL) was added in the molar amounts indicated in Table 2, and the components were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above. The results are given in Table 2.

TABLE 2
Variation in the ratios of ingredients c)/b)

| | [ABL] | [Co]/[ABL] | t_{c/bl} | t_{d} |
|---|---|---|---|---|
| | [mmol] | [mmol]/[mmol] | [min] | [min] |
| Ref. 1 | — | — | 200 | 310 |
| 7 | 0.2 | 0.2/0.2 | 75 | 260 |
| 8 | 0.4 | 0.2/0.4 | 65 | 215 |
| 9 | 0.8 | 0.2/0.8 | 45 | 165 |
| 10 | 1.2 | 0.2/1.2 | 30 | 140 |
| 11 | 1.6 | 0.2/1.6 | 25 | 100 |
| 12 | 2 | 0.2/2.0 | 25 | 80 |

A similar series was implemented using ethyl cyclopentanone-2-carboxylate (ECPC) instead of ABL as ingredient b). The results measured are set out in Table 3.

TABLE 3
Variation in the ratios of ingredients c)/b)

| | [ECPC] | [Co]/[ECPC] | t_{c/bl} | t_{d} |
|---|---|---|---|---|
| | [mmol] | [mmol]/[mmol] | [min] | [min] |
| Ref. 1 | — | — | 200 | 310 |
| 13 | 0.2 | 0.2/0.2 | 120 | 210 |
| 14 | 0.4 | 0.2/0.4 | 60 | 170 |
| 15 | 0.8 | 0.2/0.8 | 50 | 105 |
| 16 | 1.2 | 0.2/1.2 | 45 | 75 |
| 17 | 1.6 | 0.2/1.6 | 40 | 50 |
| 18 | 2 | 0.2/2.0 | 35 | 45 |

### Variation of the Activator Concentration

10.0 g of Tetrahydrofurfuryl methacrylate (SR203, Sartomer) and 0.10 g of Octa-Soligen® Cobalt-12 (Borchers, cobalt content: 12% (0.2 mmol of Co)), and different amounts, as per Table 4, of Bisomer PTE® (Cognis) were combined in a polyethylene container and mixed in a Speedmixer at 3000 rpm for 30 seconds. Subsequently 2 mmol of acetylbutyrolactone (ABL) were added, and the components were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above. The results are given in Table 4.

TABLE 4
Variation of the activator.

| | PTE | [Co]/[ABL] | t_{c/bl} | t_{d} |
|---|---|---|---|---|
| | [%]* | [mmol]/[mmol] | [min] | [min] |
| Ref. 1 | — | — | 200 | 310 |
| 19 | 0.00 | 0.2/2.0 | 30 | 40 |
| 20 | 0.25 | 0.2/2.0 | 30 | 45 |
| 21 | 0.50 | 0.2/2.0 | 30 | 55 |
| 22 | 0.75 | 0.2/2.0 | 25 | 65 |
| 23 | 1.00 | 0.2/2.0 | 25 | 80 |
| 24 | 1.25 | 0.2/2.0 | 25 | 115 |

*based on the (meth)acrylate amount.

### Variation of the (Meth)Acrylates (Ingredient a)

10.0 g of the respective (meth)acrylate as per Table 5; 0.10 g of Bisomer PTE®, (Cognis), and 0.10 g or 0 g of Octa-Soligen® Cobalt-12 (Borchers, cobalt content: 12% (0.2 mmol of Co)) were combined in a polyethylene container and mixed in a speedmixer at 3000 rpm for 30 seconds. Subsequently 2 mmol of acetylbutyrolactone (ABL) were added, and the components were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above. The results are given in Table 5.

TABLE 5
Variation of the (meth)acrylates.

| | | [Co]/[ABL] | t_{c/bl} | t_{d} |
|---|---|---|---|---|
| | (Meth)acrylate | [mmol]/[mmol] | [min] | [min] |
| Ref. 6 | 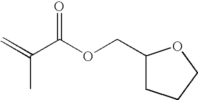 | — | 200 | 310 |
| Ref. 7 | 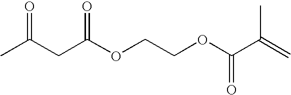 | — | 30 | 630 |
| Ref. 8 | 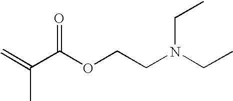 | — | >24 h | >24 h |
| Ref. 9 | 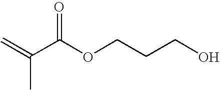 | — | 5 | 210 |
| Ref. 10 | 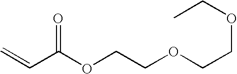 | — | 80 | 400 |
| 25 | 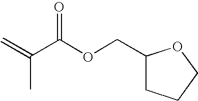 | 0.2/2.0 | 25 | 80 |
| 26 | 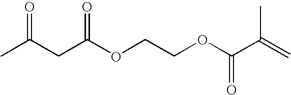 | 0.2/2.0 | 4 | 170 |
| 27 | 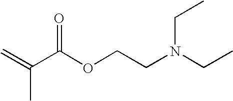 | 0.2/2.0 | 110 | 280 |
| 28 | 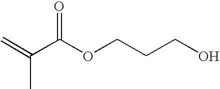 | 0.2/2.0 | 3 | 35 |
| 29 | 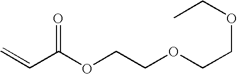 | 0.2/2.0 | 50 | 120 |

### Variation of the Metal Salt or Metal Complex Compound (Ingredient c)

10.0 g of tetrahydrofurfuryl methacrylate (SR203, Sartomer), 0.10 g of Bisomer PTE® (Cognis), and the amount of metal salt or metal complex compound indicated in Table 6 (all available from Borchers, Germany) were combined in a polyethylene container and mixed in a speedmixer at 3000 rpm for 30 seconds. Subsequently 2 mmol of acetylbutyrolactone (ABL), or 0 mmol in the reference examples, were added, and the components were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above. The results are given in Table 6.

### Production of Filled Two-Component or Pluricomponent Compositions

Filled two-component compositions were produced as per Table 7. The first component K1 was produced as follows. First of all the liquid rubber was admixed thoroughly with the (meth)acrylate in a dissolver. Thereafter, in succession, the core-shell polymer and the chalk were incorporated thoroughly by dispersion. After the mixture had been cooled to a temperature of below 30° C., the hydroperoxide, peroxide or perester was added and no degassing was carried out.

The second component K2 was produced as follows. The chalk and plasticizer and, where appropriate, acetylbutyrolactone and, where appropriate, activator were mixed thoroughly in a speedmixer. Subsequently the metal catalyst solutions were added and incorporated thoroughly by stirring, again in the speedmixer. No degassing was carried out.

The compositions of Table 8 are produced in the same way, except that in that case the acetylbutyrolactone was formulated as a constituent of component K1.

TABLE 6
Variation of the metal salt or metal complex compound.

| | | [M*]/ | | | | |
|---|---|---|---|---|---|---|
| | | [ABL] | | | | |
| | | [mmol]/ | t_{c/bl} | | t_{d} | |
| | Ingredient c) | [mmol] | [min] | | [min] | |
| Ref. 11 | Octa-Soligen ® Cobalt-12 | 0.2/0 | 200 | | 310 | |
| | (content Co: 12%) | | | | | |
| Ref. 12 | Octa-Soligen ® Mangan-10 | 0.2/0 | >24 | h | >24 | h |
| | (content Mn: 10%) | | | | | |
| Ref. 13 | Dry 0411 HS | 0.2/0 | >24 | h | >24 | h |
| | (content Mn: 7%) | | | | | |
| Ref. 14 | Dry VP-0132 | 0.1/0 | 35 | | about | |
| | (content V: 5%) | | | | 720 | |
| Ref. 15 | Octa-Soligen ® Eisen 7/8 | 0.2/0 | >5 | d | >5 | d |
| | (content Iron: 7.5%) | | | | | |

| | | | | |
|---|---|---|---|---|
| 30 | Octa-Soligen ® Cobalt-12 | 0.2/2.0 | 25 | 80 |
| | (content Co: 12%) | | | |
| 31 | Octa-Soligen ® Mangan-10 | 0.2/2.0 | 25 | ca. 600 |
| | (content Mn: 10%) | | | |
| 32 | Dry 0411 HS | 0.2/2.0 | 10 | 20 |
| | (content Mn: 7%) | | | |
| 33 | Dry VP-0132 | 0.1/2.0 | 5 | 10 |
| | (content V: 5%) | | | |
| 34 | Octa-Soligen ® Eisen 7/8 | 0.2/2.0 | about | about |
| | (content Iron: 7.5%) | | 16 h | 50 h |

*M = respective metal.

TABLE 7
Filled compositions.

| | Ref. 15 | Ref. 16 | Ref. 17 | Ref. 18 | 35 | 36 | 37 | 38 |
|---|---|---|---|---|---|---|---|---|
| K1 | | | | | | | | |
| THFMA (SR203, Sartomer) | 52 | 52 | 52 | 52 | 52 | 52 | 52 | 52 |
| Hycar ® VTBNX 1300x33 | 12 | 12 | 12 | 12 | 12 | 12 | 12 | 12 |
| Paraloid ® 2300 | 15 | 15 | 15 | 15 | 15 | 15 | 15 | 15 |
| Chalk (Socal) | 20 | 20 | 20 | 20 | 20 | 20 | 20 | 20 |
| p-Isopropyl cumene hydroperoxide (70% in | 1 | | | | 1 | | | |
| p-IPC*) | | | | | | | | |
| Cumene hydroperoxide (80% in Cumene) | | 0.69 | | | | 0.69 | | |
| Benzoyl peroxide (40% in phthalate) | | | 2.2 | | | | 2.2 | |
| Benzic acid tert-butyl perester | | | | 0.69 | | | | 0.69 |
| Total | 100.00 | 99.69 | 101.20 | 99.69 | 100.00 | 99.69 | 101.20 | 99.69 |
| K2 | | | | | | | | |
| Octa-Soligen ® Cobalt-12 HS (content Co: 12%) | 1.00 | 1.00 | 1.00 | 1.00 | 1.00 | 1.00 | 1.00 | 1.00 |
| Acetylbutyrolactone | 0.00 | 0.00 | 0.00 | 0.00 | 1.30 | 1.30 | 1.30 | 1.30 |
| Palatinol ® N (BASF) | 3.33 | 3.33 | 3.33 | 3.33 | 2.03 | 2.03 | 2.03 | 2.03 |
| Chalk (Socal) | 5.67 | 5.67 | 5.67 | 5.67 | 5.67 | 5.67 | 5.67 | 5.67 |
| Total | 10.00 | 10.00 | 10.00 | 10.00 | 10.00 | 10.00 | 10.00 | 1.00 |
| working life [min] | 60 | 60 | >24 h | 18 h | 1.8 | 3 | 4 | 3 |
| t_{d} [min] | 2.5 h | 2.5 h | >24 h | 20 h | 30 | 30 | 45 | 45 |

*p-IPC = p-isopropylcumene

TABLE 8
Filled compositions.

| | Ref. 19 | Ref. 20 | Ref. 21 | Ref. 22 | 39 | 40 | 41 | 42 |
|---|---|---|---|---|---|---|---|---|
| K1 | | | | | | | | |
| THFMA (SR203, Sartomer) | 54 | 54 | 54 | 54 | 54 | 54 | 54 | 54 |
| Hycar ® VTBNX 1300x33 | 12 | 12 | 12 | 12 | 12 | 12 | 12 | 12 |
| Paraloid ® 2300 | 15 | 15 | 15 | 15 | 15 | 15 | 15 | 15 |
| Chalk (Socal) | 18 | 18 | 18 | 18 | 18 | 18 | 18 | 18 |
| Acetylbutyrolactone | 0 | 0 | 0 | 0 | 1.3 | 1.3 | 1.3 | 1.3 |
| Cumene hydroperoxide (80% in Cumene) | 0.69 | 0.69 | 0.69 | 0.69 | 0.69 | 0.69 | 0.69 | 0.69 |
| Total | 99.69 | 99.69 | 99.69 | 99.69 | 100.99 | 100.99 | 100.99 | 100.99 |
| K2 | | | | | | | | |
| Dry VP-0132(content V: 5%) | 0.17 | 0.17 | 0.00 | 0.00 | 0.17 | 0.17 | 0.00 | 0.00 |
| Octa-Soligen ® Mangan-10(content Mn: 10%) | 0.00 | 0.00 | 0.17 | 0.17 | 0.00 | 0.00 | 0.17 | 0.17 |
| Octa-Soligen ® Cobalt-12 HS (Co content.: 12%) | 0.83 | 0.83 | 0.83 | 0.83 | 0.83 | 0.83 | 0.83 | 0.83 |
| Bisomer ® PTE (Cognis) | 0.00 | 1.00 | 0.00 | 1.00 | 0.00 | 1.00 | 0.00 | 1.00 |
| Palatinol ® N (BASF) | 3.33 | 2.33 | 3.33 | 2.33 | 3.33 | 2.33 | 3.33 | 2.33 |
| Chalk (Socal) | 5.67 | 5.67 | 5.67 | 5.67 | 5.67 | 5.67 | 5.67 | 5.67 |
| Total | 10.00 | 10.00 | 10.00 | 10.00 | 10.00 | 10.00 | 10.00 | 10.00 |
| working life [min] | 50 | 6 | 120 | 20 | 3 | 1.5 | 3 | 2.5 |
| t_{d} [h] | 3 | 3 | 3 | 3 | 2 | 1.5 | 2 | 2 |

Components K1 and K2 were introduced into a dual cartridge (K1/K2=10/1=v/v) and applied in the form of beads 1 cm wide. The “working life” reported in Tables 7 and 8 was the open time of the static mixer. The drying time was determined by sprinkling with sand (manually). The drying time t_{d} reported in Tables 7 and were the time at which the sand can be shaken off again from the bead of adhesive.

Table 9 reports the mechanical values of adhesive bonds. Here, on the one hand, the tensile strength and breaking elongation of the cured two-component compositions Ref. 16 and 36 were measured on a Zwick/Roell Z005 tensile machine in accordance with ISO 527 at 200 mm/min. On the other hand the tensile shear strengths of substrates bonded using Ref. 16 and 36 (in each case two identical substrates from Rocholl Deutschland) were measured on a Zwick/Roell 2005 tensile machine in accordance with ISO 4587/DIN EN 1465 at 10 mm/min.

TABLE 9
Two-component adhesive.

| | Ref. 16 | 36 | |
|---|---|---|---|
| Tensile strength [MPa] | 5.9 | 9.6 | |
| Breaking elongation [%] | 132 | 91 | |
| Tensile strength Alu/Alu [MPa} | 6.6 (adh.*) | 10.1 | (coh.**) |
| Tensile strength ABS/ABS [MPa] | 3.7 (adh.*) | 5.4 | (SF.***) |
| Tensile strength glass/glass [MPa] | 4.8 (adh.*) | 7.4 | (coh.**) |

*adh. = adhesive fracture
**coh. = cohesive fracture.
***SF = substrate fracture

The results from Tables 7 and 8 show that the compositions of the invention exhibit a sharp reduction in drying time. The results from Table 9 show that the compositions of the invention, apart from an increased tensile strength, more particularly feature an increased adhesion.

### Comparison of (Meth)Acrylates Against Styrene

10.0 g of the respective unsaturated compound, or mixture, as per Table 10, 0.10 g of Bisomer PTE® (Cognis), and 0.10 g of Octa-Soligen® Cobalt-12 (Borchers, cobalt content: 12%, (0.2 mmol of Co)) were combined in a polyethylene container and mixed in a speedmixer at 3000 rpm for 30 seconds. Subsequently 2 mmol of acetylbutyrolactone (ABL), or 0 mmol, were added, and the components were stirred with a magnetic stirring rod for 5 seconds. 0.08 g of cumene hydroperoxide (80% strength in cumene) was added to this solution, and stirring was carried out again with a magnetic stirring rod for 5 seconds.

Approximately 4.5 ml of the resulting mixture were applied to a glass plate provided with a margin. In this way a coating with an area of 290 mm×15 mm and a thickness of approximately 1 mm was obtained, and the base layer cure time (“t_{c/bl}”) and the drying time (“t_{d}”) were determined as described above. The results are given in Table 10.

TABLE 10
Comparison of (meth)acrylates against styrene.

| | | [Co]/[ABL] | t_{c/bl} | t_{c} |
|---|---|---|---|---|
| | Unsaturated compound | [mmol]/[mmol] | [min] | [min] |
| Ref. 1 | 10 g Tetrahydrofurfuryl | 0.2/0 | 200 | 310 |
| | methacrylate | | | |
| Ref. 23 | 10 g Styrene | 0.2/0 | >24 h | >24 h |
| Ref. 24 | 10 g Styrene | 0.2/2.0 | about | >24 h |
| | | | 12 h | |
| Ref. 25 | 8.5 g Tetrahydrofurfuryl | 0.2/0 | >24 h | >24 h |
| | methacrylate 1.5 g Styrene | | | |
| Ref. 26 | 6.25 g Tetrahydrofurfuryl | 0.2/0 | >24 h | >24 h |
| | methacrylate 3.75 g Styrene | | | |
| 1 | 10 g Tetrahydrofurfuryl | 0.2/2.0 | 25 | 80 |
| | methacrylate | | | |
| 43 | 8.5 g Tetrahydrofurfuryl | 0.2/2.0 | about | about |
| | methacrylate 1.5 g Styrene | | 150 | 300 |
| 44 | 6.25 g Tetrahydrofurfuryl- | 0.2/2.0 | about | about. |
| | methacrylat 3.75 g Styrene | | 330 | 480 |

Table 10 shows that replacing (meth)acrylate by styrene leads to a severe prolongation of the base layer cure time and of the drying time. Even the partial replacement of (meth)acrylate by styrene leads to a distinct deterioration in these values as compared with the styrene-free examples, albeit to a lesser extent than in the case of the (meth)acrylate-free systems. Moreover, a strong and very unpleasant odor was perceived with all of the styrene-containing experiments.

1. A two-component or pluricomponent composition comprising at least ingredients a), b), c) and d):
a) at least one (meth)acrylate;
b) at least one compound of the formula (I) 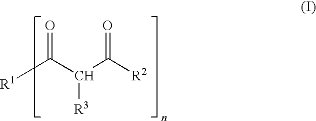
where n is a number from 1 to 20, more particularly 1, 2, 3, 4, 5 or 6;
R¹ is an n-valent organic radical;
R² is an unsubstituted or substituted alkyl group, cycloalkyl group, aryl group or aralkyl group or together with R³ forms a ring which if appropriate comprises heteroatoms in or on the ring, or is a radical OR⁴,
R⁴ being an unsubstituted or substituted alkyl group, cycloalkyl group, aryl group or aralkyl group, or together with R³ forming a ring which if appropriate comprises heteroatoms in or on the ring,
and R³ being an unsubstituted or substituted alkyl group, cycloalkyl group, aryl group or aralkyl group, or together with R² forming a ring which if appropriate comprises heteroatoms in or on the ring;
c) at least one metal salt or a metal complex compound of at least one metal selected from the group of the transition metals;
d) at least one peroxide or at least one perester or at least one hydroperoxide;
the first component K1 comprising at least ingredient c);
the second component K2 comprising at least ingredient d); and
ingredients c) and d) not being part of the same component.

2. The two-component or pluricomponent composition of claim 1, wherein R¹ is a radical R¹′(O)ₙ, where R¹′(O)ₙ is an alcohol R¹′(OH)ₙ having n hydroxyl groups, after the removal of all the protons of all the hydroxyl groups.

3. The two-component or pluricomponent composition of claim 2, wherein the alcohol is trimethylolpropane, pentaerythritol, glycerol, a sugar or a diol of the formula (II) 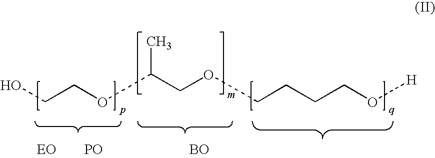
with p=0−65, m=0−65, q=0−65, the sum of m, p and q being a number from 1 to 65, and the EO and PO and BO units, if present, being blockwise or randomly distributed.

4. The two-component or pluricomponent composition of claim 2, wherein the alcohol is an OH-terminated polyurethane prepolymer which is obtainable from the reaction of at least one polyol with at least one polyisocyanate in a stoichiometric excess of the hydroxyl groups over the isocyanate groups.

5. The two-component or pluricomponent composition of claim 1, wherein n=1 and in that R¹ is an unsubstituted or substituted alkyl group, cycloalkyl group, aryl group or aralkyl group or is a radical OR⁵,
R⁵ being an unsubstituted or substituted alkyl group, cycloalkyl group, aryl group or aralkyl group or being a group of the formula (III): 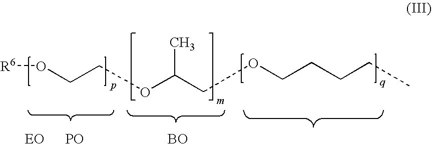
where R⁶ is a C₁ to C₄ alkyl group and
with p=0−65, m=0−65, q=0−65, the sum of m, p and q being a number from 1 to 65, and the EO and PO and BO units, if present, being blockwise or randomly distributed.

6. The two-component or pluricomponent composition of claim 1, wherein the compound of the formula (I) is a compound of the formula (IV) or (V): 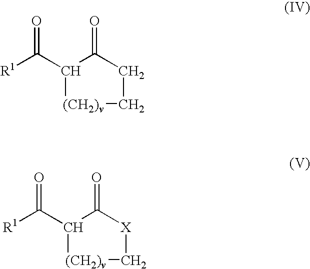
where v=1, 2 or 3 and X is an O, S or an NR⁷,
where R⁷ is H or is an unsubstituted or substituted alkyl group, cycloalkyl group, aryl group or aralkyl group.

7. The two-component or pluricomponent composition of claim 6, wherein v=1 or 2.

8. The two-component or pluricomponent composition of claim 6, wherein X═O.

9. The two-component or pluricomponent composition of claim 6, wherein formula (I) is a compound of the formula (IV) and in that R¹ is a radical OR⁵,
R⁵ being an unsubstituted or substituted alkyl group, cycloalkyl group, aryl group or aralkyl group or being a group of the formula (III): 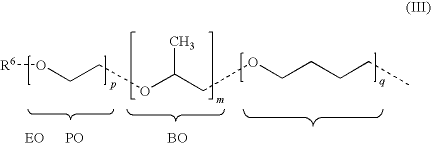
where R⁶ is a C₁ to C₄ alkyl group and
with p=0−65, m=0−65, q=0−65, the sum of m, p and q being a number from 1 to 65, and the EO and PO and BO units, if present, being blockwise or randomly distributed.

10. The two-component or pluricomponent composition of claim 6, wherein formula (I) is a compound of the formula (V) and in that R¹ is an unsubstituted or substituted alkyl group, cycloalkyl group, aryl group or aralkyl group, preferably a C₁-C₆ alkyl group.

11. The two-component or pluricomponent composition of claim 1, wherein the compound of the formula (I) is acetylbutyrolactone or ethyl cyclopentanone-2-carboxylate or methyl cyclopentanone-2-carboxylate.

12. The two-component or pluricomponent composition of claim 1, wherein the metal of the at least one metal salt or of the metal complex compound is a metal which is selected from the group containing cobalt, manganese, vanadium, iron, copper, chromium and zirconium.

13. The two-component or pluricomponent composition of claim 1, wherein the metal salt or the metal complex compound is a cobalt complex.

14. The two-component or pluricomponent composition of claim 1, wherein the composition comprises at least two metal complexes of metals which are selected from the group containing cobalt, manganese, vanadium, iron, copper, chromium and zirconium, the at least two metal complexes having different metals.

15. The two-component or pluricomponent composition of claim 14, wherein the at least two metal complexes are at least one cobalt complex and one vanadium complex or at least one cobalt complex and one manganese complex.

16. The two-component or pluricomponent composition of claim 1, wherein the at least one peroxide or the at least one perester or the at least one hydroperoxide is a hydroperoxide and more particularly cumene hydroperoxide or p-isopropylcumene hydroperoxide.

17. The two-component or pluricomponent composition of claim 1, wherein the (meth)acrylate in its ester moiety has a heteroatom, more particularly an oxygen atom, which is at least 1 but less than 5, more particularly 2 or 3, carbon atoms away from the marked oxygen atom designated by an asterisk in the formula (VI)

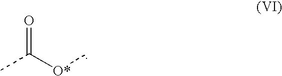

18. The two-component or pluricomponent composition of claim 1, wherein the composition is a three-component composition having a third component K3 which comprises at least ingredient a); and where
ingredient b) is part of component K1 or K2 or K3, preferably K1.

19. The two-component or pluricomponent composition of claim 1, wherein the composition is a two-component composition and where ingredient a) is part of component K1; and
ingredient b) is part of component K1 or K2, preferably K1.

20. The two-component or pluricomponent composition of claim 1, wherein the fraction of the compound of the formula (I) is 0.1% to 20% by weight, more particularly 0.1% to 10% by weight, preferably 1% to 5% by weight, based on the weight of the two-component or pluricomponent composition.

21. The two-component or pluricomponent composition of claim 1, wherein the fraction of the at least one metal salt or metal complex compound, calculated as the metal, is 0.001% to 0.5% by weight, more particularly 0.01% to 0.4% by weight, preferably 0.01% to 0.2% by weight, based on the weight of the two-component or pluricomponent composition.

22. A cured composition obtained by polymerization-curing a two-component or pluricomponent composition of claim 1 in air.

23. A method for reducing oxygen inhibition in the polymerization of (meth)acrylates utilizing a mixture comprising at least one compound of the formula (I) as described in claim 1 and at least one metal complex of at least one metal selected from the group of the transition metals.

24. A method for utilizing a two-component or pluricomponent composition of claim 1 as an adhesive, sealant or coating, more particularly as a coating.

25. A coated article obtained by a method comprising
mixing the two or plural components of a composition of claim 1
coating a substrate S1 with this mixture
curing the mixed composition in air.

26. An adhesively bonded article obtained by a method comprising the steps of
mixing the two or plural components of a composition of claim 1
applying this mixture to a surface of a substrate S1
contacting a surface of a further substrate S2 with the mixture applied to substrate S1, the substrates S1 and S2 being of the same or different material,
curing the mixed composition.

27. A sealed article obtained by a method comprising the steps of
mixing the two or plural components of a composition of claim 1
applying this mixture into a gap between two substrates S1 and S2, the substrates S1 and S2 being of the same or different material
curing the mixed composition.
